(19) United States
(12) Patent Application Publication
(10) Pub. No.: US 2020/0298290 A1
(43) Pub. Date: Sep. 24, 2020

(54) ARRANGEMENT FOR DECONTAMINATION OF A SURFACE OF OBJECTS AND METHOD FOR DECONTAMINATION OF A SURFACE OF OBJECTS

(71) Applicant: Relyon Plasma GmbH, Regensburg (DE)

(72) Inventor: Stefan Nettesheim, Regensburg (DE)

(21) Appl. No.: 16/821,522

(22) Filed: Mar. 17, 2020

(30) Foreign Application Priority Data
Mar. 18, 2019 (DE) DE102019106767.7

(51) Int. Cl. B08B 7/00

(52) U.S. Cl. CPC B08B 7/0035

(57) ABSTRACT

An arrangement and a method are disclosed for the decontamination of surfaces (2S) of objects (2) with reactive species (21). A plasma generator (1), in which active species (21) are generated, is provided in a contact chamber (10). The active species (21) are delivered to the contact chamber (10) via a dispenser valve (14) of the plasma generator (1). The delivery takes place at a predefined dew point temperature, so that a uniform condensate film (13) is deposited on the surface (2S) of the object (2).

### CROSS-REFERENCE TO RELATED APPLICATIONS

This application claims priority from German Patent Application No. 10 2019 106 767.7, filed Mar. 18, 2019, which application is incorporated herein by reference in its entirety.

### FIELD OF THE INVENTION

The present invention relates to an arrangement for decontaminating at least one surface of at least one object. The arrangement comprises a plasma generator, to which at least one inlet, one output and one energy source are assigned.

The invention further relates to a method for decontaminating a surface of at least one object with reactive species.

### BACKGROUND OF THE INVENTION

In industry plasma processes are currently used (e.g., in medical technology), material production and lighting technology. In principle, the use of plasma allows a reduction of microbial contaminants at low temperatures, whereby the effect is primarily achieved on the surfaces. The first series of tests on a laboratory scale for plasma application in the food sector mainly investigate ways of inactivating undesirable microorganisms in heat-sensitive foods. Conventional thermal decontamination processes cannot be used or can only be used to a limited extent in products such as fresh fruit and vegetables, meat or eggs. Plasma application is also considered a potential alternative to other chemical (e.g., chlorine use) or physical (e.g., high pressure, high voltage pulses, ionizing radiation) processes.

The advantages of the plasma process include but not limited to: a high effectiveness at low temperatures (usually <70° C.); goal-oriented and consumption-oriented provision; little influence on the inner product matrix; water-, solvent- and residue-free as well as resource-efficient application. Other processes, such as high pressure and/or ionizing radiation, are complex or expensive. Decontamination with UV light is often ineffective and limited by shadow effects.

German patent application DE 10 2008 037 898 A1 relates to a method and a device for disinfecting or sterilizing packaging material and/or containers and/or filter material, wherein the material or container being treated with a gas generated in a plasma reactor. The plasma treatment results in a significantly improved disinfection of the corresponding materials, in particular packaging materials and/or containers for packaging and/or storage of food, beverages and other hygienically sensitive substances. Finally, the use of plasma for the treatment of such materials or containers and correspondingly treated materials or containers is also proposed.

German patent application DE 100 36 550 A1 relates to a sterilization process in which the surface to be treated is exposed to a gas discharge. The sterilization takes place in a hydrogen and oxygen-containing gas atmosphere at a pressure of 10⁻⁴ Pa to 2×10⁻⁵ Pa. The method can be used for the sterilization of packaging materials, e.g. food packaging or labels, but also for the sterilization of surfaces in medical and/or biological and/or biotechnological applications.

German patent application DE 10 2015 119 369 A1 relates to a device and a system and a method for treating an object with plasma, in particular one or more free-form bodies. The device is used to treat an object with plasma and comprises a casing device with which an essentially gas-tight receiving space is formed or can be formed, in which an object to be treated can be accommodated. Furthermore, the device comprises a first electrode and a second electrode, the two electrodes being arranged in relation to the casing device such that a plasma can be generated in the receiving space of the casing device when an electrical potential difference is applied to the electrodes.

European patent application EP 3 085 244 A1 discloses a non-thermal plasma reactor for the sterilization of organic products.

U.S. patent application U.S. 2017/112157 A1 discloses a method for treating a surface with a reactive gas. The reactive gas is made from cold plasma at high voltage from a working gas (HVCP).

German patent application DE 10 2014 213 799 A1 discloses a household refrigeration device with a food treatment unit and a method for operating such a household refrigeration device. The household refrigerator is provided with an interior space for holding food, which is delimited by walls of an inner container. Furthermore, a food treatment unit is provided, wherein the acts on a surface, of food brought into the storage area. The food treatment unit is arranged in the household refrigeration device and designed such that the interaction is a decontamination of pesticides and/or heavy metals in the food.

German patent application DE 10 2005 061 247 A1 discloses a method and a device for sterilizing food stuff. The food stuff is exposed to at least one atmospheric plasma jet. The energy contained in the plasma jet is used to sterilize the surface of the food stuff.

German patent application DE 10 2009 025 864 A1 discloses a process for the disinfection of products which are present as solids. The product to be sterilized is first dedusted, then exposed to a cold plasma and turned during the plasma treatment. An apparatus for performing this method is also disclosed.

German patent application DE 10 2015 204 753 A1 relates to a method for attaching a substrate surface of a substrate to an adhesive surface of an adhesive. A low-temperature plasma is generated in a low-temperature plasma generator. The substrate surface and/or the adhesive surface are activated with the low-temperature plasma. The substrate surface and the surface of the adhesive composition are then layered on top of one another to form an adhesive bond.

### SUMMARY OF THE INVENTION

It is an object of the invention to provide an arrangement for the decontamination of surfaces of at least one object, wherein the thermal load on the objects should be low or negligible, and yet the entire surface of each object is being decontaminated.

The above object is solved by an arrangement for decontaminating a surface of at least one object. The arrangement comprises a plasma generator with at least one inlet and at least one outlet, an energy source is as well assigned to the arrangement. A contact chamber is fluidly connected to at least one dosing unit of the plasma generator. A dosing unit is fluidly connected to the plasma generator via the at least one inlet, so that substances for generating reactive species are supplied to the plasma generator. A support in the contact chamber receives the object, the support is provided opposite the metering unit, so that the reactive species, controlled by the metering unit, leave a uniform condensate film on the surface of the object.

Another object of the invention is to provide an automatic method for the decontamination of surfaces of at least one object, the thermal load on the objects being low or negligible and yet the entire surface of each object being decontaminated.

The above object is achieved by a method for the decontamination of surfaces of objects with reactive species, which comprises the following steps:
positioning at least one object on a support in a contact chamber;
feeding substances to a plasma reactor from a dosing unit, wherein reactive species being formed therefrom in the plasma reactor;
passing the reactive species into the contact chamber via a further metering unit assigned to the plasma reactor, wherein via the metering unit an inlet mixture and the dew point temperature are being set; and,
setting the dew point temperature of the reactive species at the transition of the metering unit into the contact chamber such that the dew point temperature is greater than a temperature of the object, so that a uniform condensate film is formed on the surface of the object.

According to the invention, the arrangement for decontaminating a surface of at least one object comprises a plasma generator, which is assigned at least one inlet, one output and one energy source. A contact chamber of the arrangement is fluidly connected to at least one dosing unit of the plasma generator. Depending on the type of treatment of the object, the dosing unit of the plasma generator can be a plasma generated in the plasma generator, a radiation, long-living radicals, metastable and inhibitory substances or exclusively reactive species. Another metering unit is fluidly connected to the plasma generator via the at least one inlet. The plasma generator can thus be supplied with substances which are used to generate reactive species or long-living radicals and metastable substances. A support for receiving the object to be treated is provided in the contact chamber. The support is arranged opposite the dosing unit, so that the reactive species emerging from the dosing unit in a controlled manner can form a uniform condensate film on the surface of the object.

The reactive species entering the contact chamber from the metering unit have a dew point temperature that is greater than an object temperature. An energy source is assigned to the plasma generator, with which the temperature in the plasma generator can be set. The energy source and the metering unit are connected to a control of the arrangement, so that the dew point temperature of the reactive species can be set as desired.

In order to achieve a uniform condensation of the reactive species on the surface of the object, the support can have a movement device for receiving the object in the contact chamber. The movement device moves the object in such a way that the uniform condensate film can be formed by the reactive species on the surface of the object.

A distance between the object lying on the support or on the movement device and the dosing unit can be set. This allows the object to be positioned and treated to be positioned in relation to the dosing unit. This allows you to set different treatment modes for the object.

According to a possible embodiment, the plasma generator can be provided outside the contact chamber.

The method according to the invention for the decontamination of surfaces of objects with reactive species is characterized in that at least one object is first positioned on a support in a contact chamber. Subsequently, substances selected for the treatment of the object are supplied to a plasma reactor by a dosing unit. Reactive species being formed therefrom in the plasma reactor. The reactive species can be brought into the contact chamber via a further metering unit assigned to the plasma reactor. An inlet mixture and the dew point temperature being set via the metering unit. A controller is provided which is connected to the plasma reactor, an energy source for the plasma reactor and as well the metering unit. As a result, the dew point temperature of the reactive species at the transition of the metering unit into the contact chamber can be set such that the dew point temperature is greater than a temperature of the object, so that a uniform film of condensate is formed on the surface of the object.

The method according to the invention has the advantage that the uniform precipitation of the condensate film on the surface of the object achieves effective and, essentially, safe decontamination in all areas of the surface of the object.

The decontamination is supported by a movement device with which the at least one object to be treated is moved during the treatment period together with the reactive species. The movement of the object supports the formation of a uniform condensate film of the reactive species on the surface of the object and in parallel, all surface areas of the object are reached.

An energy source is assigned to the plasma generator, with which the temperature in the plasma generator is stabilized by heating or cooling. This is also conducive to the formation of the uniform condensate film, since the dew point temperature can be set as required.

After treating the object with the reactive species, the object can be placed in a door lock for drying. The lock is equipped with a further heating or cooling, with which the temperature for drying in the door lock can be set. This allows the drying process to be optimally adapted to the conditions of the object.

To control and regulate the decontamination, a control unit is communicatively connected to several elements for setting and/or maintaining the conditions in the contact chamber. The elements include, but are not limited to, the dosing unit, the circulation fan, the further dosing unit, the plasma generator, the energy source of the plasma generator, at least one sensor, the drive unit for the movement unit, the heating/cooling, the filter unit and the door lock.

### Definition

Decontamination in connection with the present invention is defined as the removal of dangerous or harmful impurities (contaminations) from people, objects, for example food, clothing, plants, animals, floors, solids, liquids.

The harmful contaminants can be chemical or biological in nature. Of particular note are: toxic, organic compounds, all kinds of microorganisms (viruses, bacteria, fungi, spores, primitive parasites).

### BRIEF DESCRIPTION OF THE DRAWINGS

In the following, exemplary embodiments are intended to explain the invention and its advantages with reference to the attached figures. The proportions in the figures do not always correspond to the real proportions, since some shapes are simplified, and other shapes are shown enlarged in relation to other elements for better illustration. The figures show:

FIG. 1 is a schematic diagram of a possible selection of substances (organic substances) that may be present on the surface of the object;

FIG. 2 is a schematic representation of the treatment of an object with a plasma and its transfer to the environment;

FIG. 3 is a schematic representation of an embodiment of the arrangement according to the invention for treating objects with a plasma or reactive species;

FIG. 4 is a schematic representation of an object with a condensate film condensed on the surface;

FIG. 5 is an exemplary representation of the plasma reactor and the parameters required for operating the same; and,

FIG. 6 a schematic representation of a possible embodiment of the arrangement for the treatment of objects with plasma or reactive species.

### DETAILED DESCRIPTION OF EMBODIMENTS OF THE INVENTION

Identical reference numerals are used for identical or identically acting elements of the invention. Furthermore, for the sake of clarity, only reference numerals are shown in the individual figures which are necessary for the description of the respective figures.

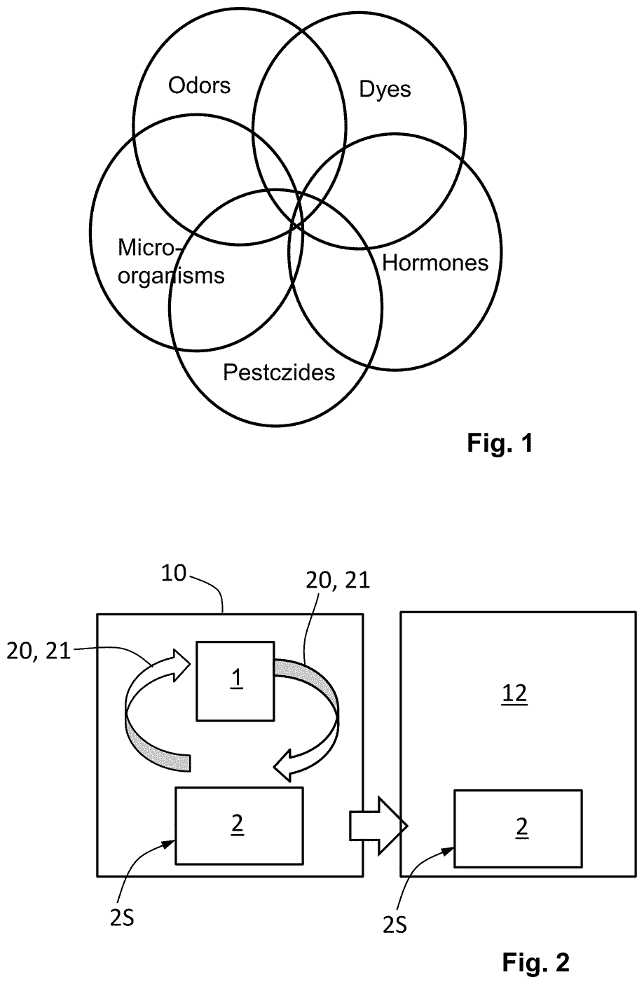

FIG. 1 shows a schematic representation of the substances (organic substances) that may be present on the object (not shown here). The organic substances include, but are not limited to, odors (odor molecules), dyes, hormones, pesticides or microorganisms.

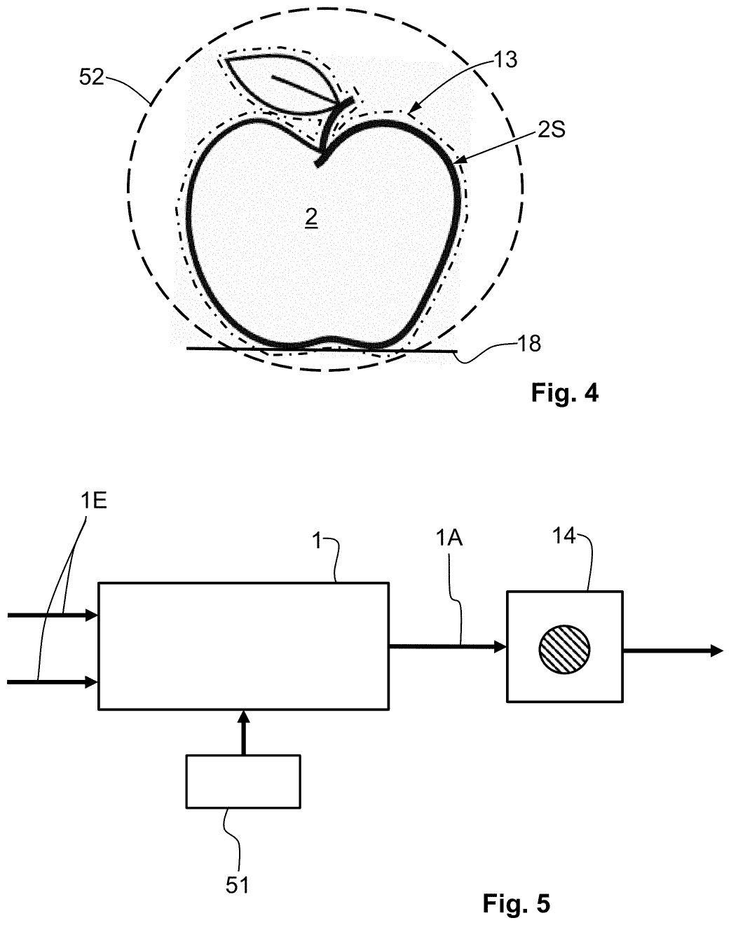

FIG. 2 shows a schematic representation of the treatment of an object 2 with a plasma 20 and reactive species 21 respectively, in order to achieve decontamination of the surface of the object 2S (see FIG. 4). The plasma 20 and the reactive species 21 respectively are generated using a plasma generator 1. The plasma 20 and the reactive species 21 respectively remaining in the treatment in the chamber 10 are used again by the plasma generator 1 to generate plasma 20 and reactive species 21 respectively. After the treatment (exposure time) with the plasma 20 and the reactive species 21 respectively, the object 2 can be exposed to the normal environment 12. It is advantageous if the object 2 is treated with very moist plasma 20 and the reactive species 21 respectively. The moist plasma 20 and the reactive species 21 respectively accelerate and improve the treatment, since with a suitable setting of the parameters of the arrangement, the moist plasma 20 and the reactive species 21 respectively condense on a surface 2S of the object 2 and thus all areas of the surface 2S of object 2 can be reached. The treatment essentially concerns a surface 2S of at least one object 2. The improvements or accelerations are in the treatment of food, in the breakdown of fungal attack on the surface, in the pesticide breakdown, in the reduction of odors, in the bleaching of organic colors or in the removal achieved by bacteria from food packaging. The table below shows the oxidation potential of the various molecules or radicals formed in the wet plasma:

Oxidation potential [eV] (Standard oxidation potential)

| | | |
|---|---|---|
| F₂ | fluorine | 3.06 |
| *OH | hydroxyl radical | 2.8 |
| *O | atomic oxygen | 2.42 |
| O₃ | ozone | 2.08 |
| H₂O₂ | hydrogen peroxide | 1.77 |
| HClO | hypochlorous acid | 1.49 |
| Cl₂ | chlorine | 1.36 |
| ClO₂ | chlorine dioxide | 1.27 |
| O₂ | oxygen | 1.23 |

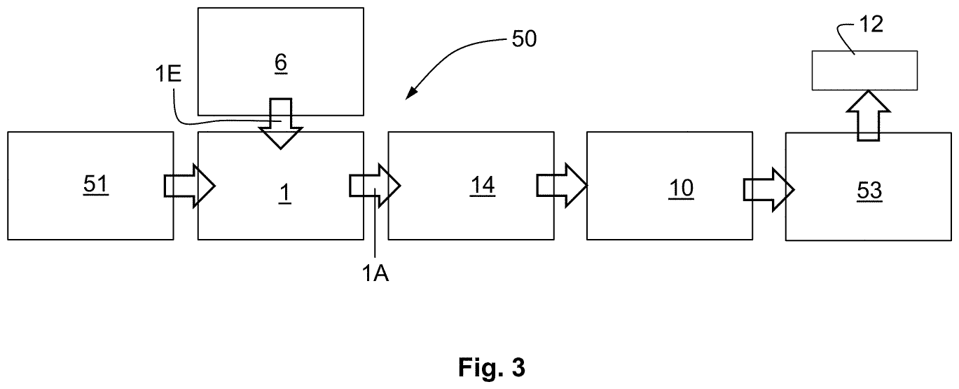

FIG. 3 shows a schematic representation of an embodiment of the arrangement 50 according to the invention for treating objects 2 with a plasma 20 and reactive species 21 respectively. The arrangement 50 comprises the plasma generator 1, to which an energy source 51 is assigned. The energy source 51 may include a heat source, a heat sink, an electrical potential, or light (hu). The energy source 51 acts in a suitable manner on the plasma generator 1 and plasma reactor respectively in order to generate a plasma according to the predetermined parameters and to set the required dew point and the dew point temperature respectively.

The plasma generator 1 has at least one inlet 1E, via which a dosing unit 6 is connected to the plasma generator 1. About the dosing unit 6, the plasma generator 1 additives, for example like H₂O, O₂, N₂, trace gas, salts, acids and/or organic compounds. The dosing unit 6 is used to set the inlet mixture for the plasma generator 1 and the dew point of the plasma 20 formed or the reactive species 21.

The plasma generator 1 has an outlet 1A, via which the plasma 20 passes from the plasma generator 1 to a further metering unit 14, which can be designed as a metering valve, dispenser valve, dispenser nozzle, opening or outlet. Via the dispenser valve 14, the excited additives, such as for example: H₂O, O₂, N₂, O₃, H₂O₂, OH, HNO₃, HNO₂, NOX and/or organic compounds.

For the treatment of the object 2 in the contact chamber 10 or in the contact area 52, parameters such as for example: time (residence time of the object 2 in the contact chamber 10 or in the contact area 52), temperature (temperature in the contact chamber 10 or in the contact area 52), dose of the excited additives acting on the object 2, pH value and/or the dew point (temperature on the surface 2S of the object 2) is set such that the temperature falls below the dew point on the surface 2S of the object 2. By falling below the dew point on the surface 2S of the object 2, a uniform condensate film 13 is formed on the surface 2S of the object 2. This ensures that all areas of the surface 2S of the object 2 are reached by the plasma 20 or the reactive species 21, from which an effective decontamination of the surface 2S of the object 2 can be achieved (not shown).

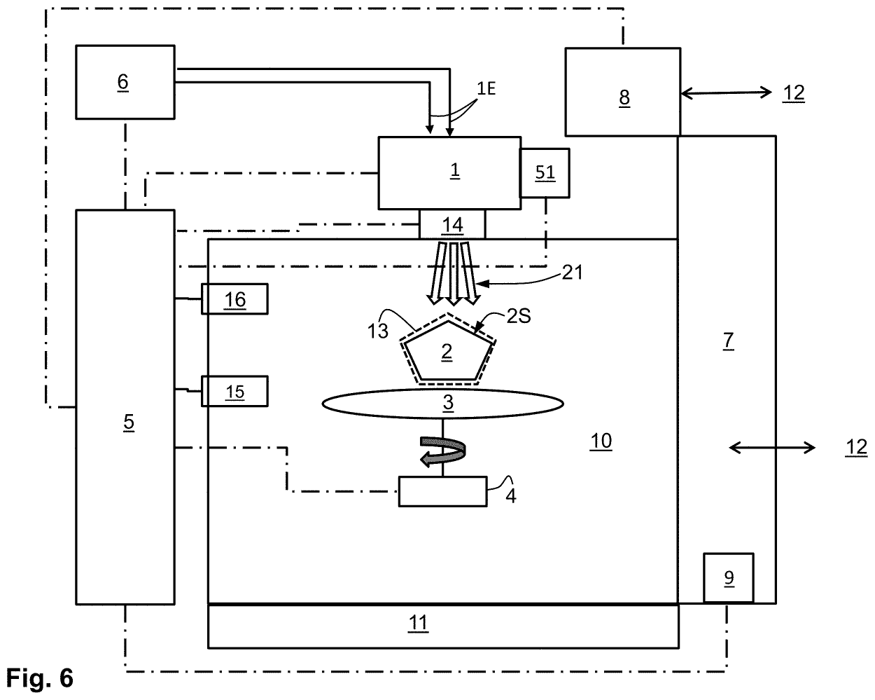

After treatment of the object 2 with the plasma 20 and the reactive species 21 respectively, the object 2 is removed from the contact chamber 10 or the contact area 52 via a removal lock 53. The appropriately treated object 2 can be supplied to the regular environment 12. Parameters, for example: degradation time of the reactive species 21, ventilation and/or drying of the object 2 can be set. The contact area 52, in which the plasma 20 and the reactive species 21, respectively condenses on the surface 2S of the object 2, can be designed as a closed area in the form of the contact chamber 10. It is also conceivable that the object 2 to be treated of the further dosing unit 14 is provided at the outlet 1A of the plasma generator 1. In this possible embodiment, the plasma generator 1 and the object 2, to be treated, are located in a common contact chamber 10 (see FIG. 6). The plasma 20 and the reactive species 21 respectively pass directly from the further dosing unit 14 at the outlet 1A of the plasma generator 1 to the contact area 52 in order to condense on the object 2.

FIG. 4 shows, for example, an object 2 whose surface 2S is to be treated with the plasma 20 and the reactive species 21 respectively. Object 2 is an apple, but this should not be interpreted as a limitation of the invention. As already mentioned at the beginning, the object 2 can be a multiplicity of objects which have regular or irregularly shaped surfaces 2S. In order that the moist plasma 20 with the large number of reactive species 21 can be deposited on the surface 2S of the object 2, the dew point or the dew point temperature of the moist plasma 20 with the reactive species 21 must be set. It is also advantageous if the object 2 is held on a support 18 with openings (not shown) or on the support 18 with as few support points (not shown) as possible, so that the moist plasma 20 with the reactive species can largely precipitate on the whole surface 2S of the object 2.

Furthermore, it is conceivable that the object 2 is rotated within itself during the treatment with the moist plasma 20 with the reactive species 21, so that each section of the surface 2S of the object is exposed to the moist plasma 20 with the reactive species 21.

FIG. 5 shows an example of the plasma generator 1 (plasma reactor) in which the moist plasma 20 is generated with the reactive species 21. In order to obtain the moist plasma 20 with the reactive species 21 at a predetermined dew point temperature and the desired composition, a number of parameters must be observed. The plasma generator 1 is, for example, supplied with air at a predetermined rate via an inlet 1E (the rate can be, for example, from 0-1 l/min). Likewise, water can be supplied to the plasma generator 1 via a further or the same inlet 1E at a predetermined rate (the rate can be, for example, 0-1 g/min). It is self-evident to a person skilled in the art that the ranges given are only an example, which should not be interpreted as a limitation of the invention. If, for example, a power for generating the moist plasma 20 with the reactive species 21 is supplied to the plasma generator 1, this is composed of a thermal power dQₜₕ and an electrical power dQₑ.

The example below shows that the power required for an initial temperature Tₒᵤₜ of 100° C. of the plasma 20 with the reactive species 21 is 100 W at a 1:1 ratio between water and air.

1.18 g/60 s*2 J/(g*K)*80K=3.14 W For air gilt:

1 g/60 s*4.18 J//g*K)=5.57 W For water (l):

1 g/60 s*2260 J/g=37.7 W For water (g):

The total power Pₜₒₜₐₗ=46 W, so that the power loss Pₗₒₛₛ=54 W.

From the plasma generator 1 the moist plasma 20 with the reactive species 21 is fed via the further metering unit 14 of the contact chamber 10 (see FIG. 3) or a contact area 52 (see FIG. 6) to the treatment of the object 2 with the moist plasma 20 and the reactive species 21.

The plasma 20 alone and/or the plasma 20 with the reactive species 21 can influence the object 2 in various ways, depending on the composition and the direct, semi-direct or indirect effect.

When used directly, the plasma 20 is in direct contact with the object 2. The interaction with object 2 is based on radiation (VUV, UV), charged molecules, radicals and reactive particles. Examples of direct application are for example, a jet plasma or a plasma that is generated by means of dielectric barrier discharge.

In the case of semi-direct application, the distance A between the exit of the plasma at the plasma generator 1 and the object 2 is dimensioned such that it is greater than the mean free path length. There is therefore no direct interaction between the charged particles of the plasma and the object 2. The antimicrobial effect is caused by radiation, long-living radicals and metastable and inhibitory substances. Examples of the semi-direct application are a semi-dielectric barrier discharge with a distance A from object 2 or the Sterrad-method, which relates to sterilization at low temperature with hydrogen peroxide (not shown).

There are two possible methods for the indirect method. With the first method, the object 2 is irradiated with UV or VUV light. The plasma is enclosed in the UV or VUV transparent reactor. Consequently, the object 2 has no interaction with charged particles. The plasma formed in UV lamps emits UV light required for sterilization. With the second method, the plasma is used for gas or liquid treatment. Examples of the application are for example an ozone generator for drinking water preparation or PLexc processed air (PPA).

According to a possible exemplary embodiment (see FIG. 4), which cannot be interpreted as a limitation of the invention, an object 2 (such as an apple) is treated. The effect of the reactive species 21 on the object 2 being indirect and/or semi-direct. The reactive species 21 continue to act in a thin condensate film even after the active exposure phase. The thermal load on object 2 remains low, since the volume of the object 2 is scarcely warmed even in the case of brief exposure to an active atmosphere. In case, for example, a thin, predominantly aqueous, film is deposited on the surface 2S of the object 2, the film of approximately 1 μm in thickness already has a considerable effect on the chemical compounds and biological species on the surface 2S. For example, the total heat of condensation that is released on 100 cm² of the surface 2S of the object 2 is only 20 J. This would heat an object weighing 100 g by approx. 0.1 K only.

However, the surface 2S of the object 2 can experience a temperature jump up to the dew point temperature prevailing in the contact chamber 10 at the moment of condensation with a layer thickness of up to 1 μm. During these condensation processes, all reactive species 21 act particularly effectively with the surface 2S.

FIG. 6 shows a schematic illustration of a possible embodiment of the arrangement for treating objects 2 with reactive species 21 which were excited by a plasma 20. The plasma 20 is preferably an atmospheric cold plasma, a non-equilibrium plasma or a DBE (dielectric barrier discharge). The plasma power is between 10 W and 1000 W, preferably at 100 W. The thermal power is between 10 W and 1000 W, preferably 100 W.

In a contact chamber 10, a plasma generator 1 (plasma reactor) is provided, by means of which the generation of a plasma 20 and/or reactive species 21 can be carried out. The composition of the reactive species 21 depends on the object 2 to be treated. In the embodiment shown here, the object 2 to be treated is positioned on a movement device 3. The movement device 3 can take various possible configurations, for example: a turntable, a linear movement mechanism or a 3-dimensional movement mechanism. The movement device 3 is moved in a suitable manner via a drive unit 4, so that the entire surface 2S of the object 2 is accessible to the reactive species 21 if possible. A control unit 5 is connected to several elements which are necessary for the setting and/or compliance with the conditions in the contact chamber 10. The elements include a dosing unit 6, a circulation blower 16, a further dosing unit 14, the plasma generator 1, an energy source 51 of the plasma generator 1 (not shown), at least one sensor 15, the drive unit 4, a heating/cooling 9, a filter unit 8, which leads to the environment 12, and a door lock 7, which leads to the environment 12. The dosing unit 6 is connected to the plasma generator 1 via its at least one inlet 1E, so that the substances, for example air, water and/or other active additives can be supplied. The active additives consist of organic acids, alcohols and hydrogen peroxide. The energy source 51 assigned to the plasma generator 1 serves to stabilize the temperature in the plasma generator 1, which can be done by heating or cooling.

A dosing unit 14, which is designed in the form of a dispenser valve, is assigned to the plasma generator 1, so that the reactive species 21 generated in the plasma generator 1 are dispensed into the contact chamber 10. The movement device 3 is used for uniform exposure of the object 2 to reactive species 21. A reactive condensate film 13 from reactive species 21 is deposited on the surface 2S of the object 2. The excess condensate is separated from the contact chamber 10 via a condensate separator 11. The ventilation or the regulated ventilation of the contact chamber 10 takes place via a filter unit 8 (filter system). The filter unit 8 is constructed from activated carbon or comprises catalytically active material for the degradation of reactive species 21 or by-products, such as for example ozone and nitrogen oxides and hydrogen peroxide.

For drying the object 2, another one of the heating/cooling 9 is assigned for example to the door lock 7. The door lock 7 is provided with a locking device (not shown) in order to block an opening during the active exposure of the object 2 with the reactive species 21.

The at least one sensor 15 is used to monitor the interior (temperature, humidity, gas composition). The circulation blower 16 is used to mix the gas phase in the contact chamber 10. The control unit 5 is used for process control and process monitoring and for this purpose is communicative with the movement device 3, the drive unit 4, the metering unit 6, the energy source 51 of the plasma generator 1, the dispenser valve 14, and the circulation blower 16, the at least one sensor 15, the heating/cooling 9 of the door lock 7 and the door lock 7.

Abrupt changes in the pH value on the surface of the object 2, brief temperature jumps on the surface 2S of the object 2, the development of a reactive (oxidative) condensate film 13 on the surface 2S of the object 2 and the exposure of the object 2 with reactive oxygen species, can be monitored in the contact chamber 10.

The arrangement and method according to the invention are used essentially for the decontamination of foods.

The invention has been described in terms of preferred embodiments. However, it is self-evident for a person skilled in the art can make changes and modifications without leaving the scope of protection of the protection claims below.

### LIST OF REFERENCE NUMBERS

1 Plasma generator
1A Outlet
1E Inlet
2 Object
2S Surface of the object
3 Movement device
4 Drive unit
5 Control unit
6 Dosing unit
7 Door lock
8 Filter unit
9 Heating/cooling
10 Contact chamber
11 Condensate separator
12 Environment
13 Condensate film
14 Dosing unit, Metering unit
15 Sensor
16 Circulation blower
18 Support
20 Plasma
21 Reactive species
50 Arrangement
51 Energy source
52 Contact area
53 Removal lock
A Distance

1. An arrangement for decontaminating a surface of at least one object, the arrangement comprises:
a plasma generator with at least one inlet and at least one outlet;
an energy source;
a contact chamber, which is fluidly connected to at least one dosing unit of the plasma generator;
a dosing unit, which is fluidly connected to the plasma generator via the at least one inlet, so that substances for generating reactive species are supplied to the plasma generator; and,
a support in the contact chamber for receiving the object, which is provided opposite the metering unit, so that the reactive species, controlled by the metering unit leave a uniform condensate film on the surface of the object.

2. The arrangement according to claim 1, wherein the reactive species entering the contact chamber from the metering unit have a dew point temperature that is greater than a temperature of the object.

3. The arrangement according to claim 1, wherein a movement device is provided in the contact chamber for receiving the object and wherein the movement device moves the object such that the uniform condensate film of reactive species is formed on the surface of the object.

4. The arrangement according to claim 1, wherein a distance between the object and the metering unit is adjustable, in order to position the object to be treated on the support with respect to the metering unit.

5. The arrangement according to claim 1, wherein the plasma generator is provided outside the contact chamber.

6. A method for the decontamination of surfaces of objects with reactive species, comprises the following steps:
positioning at least one object on a support in a contact chamber;
feeding substances to a plasma reactor from a dosing unit, wherein reactive species being formed therefrom in the plasma reactor;
passing the reactive species into the contact chamber via a further metering unit assigned to the plasma reactor, wherein via the metering unit an inlet mixture and the dew point temperature are being set; and,
setting the dew point temperature of the reactive species at the transition of the metering unit into the contact chamber such that the dew point temperature is greater than a temperature of the object, so that a uniform condensate film is formed on the surface of the object.

7. The method according to claim 6, wherein the support is a movement device with which the at least one object to be treated is moved during the treatment period with the reactive species, so that the uniform condensate film of the reactive species is formed on the surface of the object.

8. The method according to claim 6, wherein an energy source is assigned to the plasma generator, with which a stabilization of the temperature in the plasma generator is achieved by heating or cooling.

9. The method according to claim 6, wherein after the treatment of the object with the reactive species, the object is placed in a door lock for drying, which has a further heating/cooling, with which the temperature for drying in the door lock is set.

10. The method according to claim 6, wherein a control unit is communicatively connected with a plurality of elements for setting and/or maintaining the conditions in the contact chamber, wherein the elements comprise the dosing unit, a circulation blower, the further metering unit, the plasma generator, the energy source of the plasma generator, at least one sensor, the drive unit, the heating/cooling, a filter unit and a door lock.
